(19) United States
(12) Patent Application Publication
(10) Pub. No.: US 2026/0169821 A1
(43) Pub. Date: Jun. 18, 2026

(54) REAL-TIME FORECASTING AND ADAPTIVE SCALING OF DISTRIBUTED WORKERS USING ARTIFICIAL INTELLIGENCE

(71) Applicant: NVIDIA Corporation, Santa Clara, CA (US)

(72) Inventors: Bojan Vukojevic, Pleasanton, CA (US); Bora Mukadder Oztekin, Mountain View, CA (US); Nagesh Prafulla Bhole, Pune (IN); Sanjay Saxena, San Jose, CA (US); Frank James Spitulski, Gilroy, CA (US); James Cameron, Fredericton (CA); Dmitry Mikhaylov, Hayward, CA (US); Cameron Moore, San Jose, CA (US)

(21) Appl. No.: 18/978,688

(22) Filed: Dec. 12, 2024

(51) Int. Cl. G06F 9/50; G06F 9/54

(52) U.S. Cl. CPC G06F 9/5077; G06F 9/54; G06F 2209/5019; G06F 2209/548

(57) ABSTRACT

Systems and techniques for real-time forecasting and adaptive scaling of distributed workers using artificial intelligence (AI) is disclosed. The techniques include receiving first metrics including a first number of work requests for a first task received within a first predetermined duration. The techniques further include applying an AI model to the first number of work requests for the first task to obtain a first predicted number of future work requests for the first task, wherein the AI model comprises a prediction function comprising one or more autoregressive terms and Fourier series terms. The techniques further include causing the first predicted number of future work requests for the first task to be provided to a worker controller for managing a first plurality of workers deployed within a first compute environment to execute the first task.

### TECHNICAL FIELD

At least one embodiment pertains to distributed workload systems and, more specifically, to scaling the number of distributed workers of the distributed workload system.

### BACKGROUND

A distributed workload system can use a network of workers to perform one or more tasks. The workers can be configured to evaluate work requests as the work requests are added to a queue. The number of workers can be scaled up or down based on the amount of work that needs to be performed. If there are too many workers, resources can be wasted. If there are not enough workers, latency can increase.

### BRIEF DESCRIPTION OF THE DRAWINGS

FIG. 1 is a block diagram of an example distributed workload system for real-time forecasting and adaptive scaling of distributed workers using AI, according to at least one embodiment.

FIG. 2 is a flow diagram of an example method for forecasting work requests using artificial intelligence, according to at least one embodiment.

FIG. 3 is a flow diagram of an example method for real-time forecasting and adaptive scaling of distributed workers using AI forecasting, according to at least one embodiment.

FIG. 4 is a flow diagram of an example method for forecasting additional workers using queue sizes, according to at least one embodiment.

FIG. 5 is a block diagram illustrating an exemplary computer system, in accordance with at least one embodiment of the present disclosure.

FIG. 6A illustrates inference and/or training logic, according to at least one embodiment of the present disclosure.

FIG. 6B illustrates inference and/or training logic, according to at least one embodiment.

FIG. 7 illustrates training and deployment of a neural network, according to at least one embodiment.

FIG. 8 is an example data flow diagram for an advanced computing pipeline, according to at least one embodiment.

FIG. 9 is a system diagram for an example system for training, adapting, instantiating and deploying machine learning models in an advanced computing pipeline, according to at least one embodiment.

### DETAILED DESCRIPTION

Existing solutions for scaling workers of a distributed workload system often measure one or more metrics and then react to the metric (e.g., scale the number of workers up, scale the number of workers down, etc.) if the metric satisfies a particular criterion. For example, the central processing unit (CPU) utilization can be measured, and if the CPU utilization exceeds an upper threshold value, the number of workers can be scaled up. If the CPU utilization falls below a lower threshold value, the number of workers can be scaled down. This reactive approach can fail to work efficiently across different clusters of workers and/or across different worker computing environments. This reactive approach can also fail to respond well to repeated patterns of requests, such as patterns that repeat daily, weekly, monthly, etc.

Aspects of the present disclosure address the above and other deficiencies by providing for systems and techniques for real-time forecasting and scaling of distributed workers using artificial intelligence (AI) and/or queue-based scaling. A worker refers to a component (e.g., an instance of a software application or module) that performs particular tasks or computations in response to work requests issued as part of a larger operation. In a distributed system, additional workers can be added to handle an increased number of work requests, or conversely some existing workers can be removed in response to a reduced number of work requests. According to aspects of the present disclosure, metrics can be gathered over time and used to train an AI model (e.g., machine learning model) to predict the number of work requests that will be received in the future. For example, the collected metrics can include the number of work requests received in a predetermined duration (e.g., work requests received per second, work requests received per minute, work requests received per 15 minutes, etc.), the resource (e.g., CPU, graphics processing unit (GPU), memory, etc.) utilization of devices hosting the workers, the amount of time it takes for a worker to process a work request, and/or the like. In some embodiments, metrics are collected from multiple clusters of workers and/or computing environments hosting workers. The metrics can be aggregated to provide local and global predictions.

Based on the collected metrics, a machine learning model can predict how many work requests are expected to be received within a predetermined time in the future. In some embodiments, the number of work requests that are expected to be received within a predetermined time in the future can be represented using a prediction function. The prediction function can include one or more weighted terms. In some embodiments, the terms can include one or more of the collected metrics, one or more autoregressive terms, and/or one or more Fourier series terms. For example, one or more of the Fourier series terms of the prediction function can be weighted sine and/or cosine functions.

In some embodiments, the prediction function may be represented using the following formula:

$${y}_{t} = {α}_{0} + {\sum }_{i = 1}^{M} {β}_{i} {y}_{t - 1} + {\sum }_{j = 1}^{N} {y}_{i} sin ( 2 π j \frac{t}{m} ) + {\sum }_{j = 1}^{N} {δ}_{i} cos ( 2 π j \frac{t}{m} ) + … + {ϵ}_{t}$$

where yₜ is the predicted number of work requests at time t, α represents an intercept term, β represents autoregressive terms, γ represents first Fourier series terms (e.g., sine terms), δ represents second Fourier series terms (e.g., cosine terms), M represents the number of autoregressive lags, N represents how many Fourier orders should be included, m represents the length of the seasonal period (e.g., 1440 minutes (1 day)), and ϵₜ represents an error or noise term at time t. In some embodiments, the prediction function can include one or more additional terms not shown in the above formula. In some embodiments, the prediction function does not include all of the terms shown in the above formula.

The optimal weights for each term can be learned by the machine learning model over time. In some embodiments, the machine learning model uses an iterative process (e.g., gradual descent) to determine optimal weights. In some embodiments, the machine learning model can use a single iteration (e.g., using a linear regression algorithm) to determine optimal weights. For example, optimal weights can be determined using an ordinary least squares algorithm, a weighted least squares algorithm, a generalized least squares algorithm, a ridge regression algorithm, a lasso regression algorithm, or the like. Using the optimal weights and the prediction function, the predicted number of work requests can be calculated. Because the optimal weights can be calculated in a single iteration, the weights can be updated quickly based on new metrics, allowing for real-time (or near real-time) predictions of future numbers of work requests.

Based on the predicted number of work requests and the collected metrics, a number of workers needed at the future time can be calculated. In some embodiments, the number of future workers needed can be calculated based on a minimum and/or maximum number of workers allowed by a user associated with the workers. In some embodiments, the number of future workers needed can be calculated based on the amount of time (e.g., average amount of time) required to process a work request and the amount of time that is required to start new workers. The number of future workers needed can be calculated to balance the response latency (e.g., the amount of time required to respond to a work request) and the cost associated with the number of resources (e.g., GPU resources) consumed.

If the number of workers needed at the future time is more than the current number of workers, additional workers can be started (e.g., respective software applications or modules can be instantiated) to prepare for the predicted additional work requests. If the number of workers needed at the future time is less than the current number of workers, one or more workers can be stopped to use fewer computing resources. In some embodiments, workers are only started/stopped based on satisfaction of one or more criterion. For example, additional workers may only be started if the predicted number of work requests exceeds a predetermined threshold. As another example, additional workers may only be started if current resource utilization metrics (e.g., CPU utilization, GPU utilization, etc.) exceed a predetermined upper threshold. In some embodiments, workers may only be stopped if current resource utilization metrics fall below a predetermined lower threshold.

In some cases, the number of work requests received is different than the prediction (e.g., because historical data has not been collected yet, because the number of work requests is deviating from historical patterns, etc.), which can cause work requests to build up in a queue because there are not enough workers to process the requests. A new number of workers needed can be determined using one or more algorithms based on a size of the queue. For example, an amount of excess work in the queue can be calculated based on a current size of the queue, an average time it takes for a worker to process a work request, and the number of workers that are processing work requests or starting up.

If there is excess work in the queue, one or more workers can be started up based on a start-up time of the worker process. For example, consider that there is 35 minutes of excess work in a queue and that a new worker takes 15 minutes to start up (e.g., a new instance of a respective application or module takes 15 minutes to be created and to start executing). If one worker is added, it will take 50 minutes to clear the queue (15 minute startup+35 minutes of work). If two workers are added, they can start in parallel, and it will take about 33 minutes to clear the queue (15 minute startup+(35 minutes of work/2 workers)). If three workers are added, they can start in parallel, and it will take 27 minutes to clear the queue (15 minute startup+(35 minutes of work/3 workers)).

Because there is a queue, at least one worker can be added to reduce the size of the queue. When adding the second worker process, the extra worker is blocked for 15 minutes, but 17 minutes of time is saved overall, so it can be advantageous to add the second worker process. When adding the third worker process, the extra worker is blocked for 15 minutes, but only 6 minutes of time is saved overall, so it may not be advantageous to add the third worker process.

The number of additional workers that should be added can be represented by the following formula:

$$\frac{q}{( n ) ( n + 1 )} = s$$

where q is the amount of excess work in the queue, s is the startup time of a worker process, and n is the new number of additional workers that should be added. In some embodiments, n can be rounded up to the nearest whole number, and any negative solutions can be discarded. For example, using the example from above, the formula become

$$\frac{35}{( n ) ( n + 1 )} = 15 .$$

Solving for n gives: n≈−2.1, 1.1. Discarding the negative solution and rounding up gives n=2 as the number of additional workers that should be added to handle the excess work in the queue.

In some embodiments, a term k can be added to the formula to adjust the number of instances that are added based on an amount of currently available resources:

$$\frac{k q}{( n ) ( n + 1 )} = s$$

In some cases, k can be proportional to an amount of available resources. For example, as the number of available resources increases, k can increase, and vice versa. The value of k can represent what the ratio of the startup time of a worker compared to the time saved overall needs to be in order for an additional worker to be worthwhile. For example, when k=2, it may be worthwhile to add an additional worker with a startup time of 40 minutes if 20 minutes of time is saved overall

$$( \frac{s}{saved time} = k ) .$$

In some embodiments, the AI forecasting model can be used at the same time as the queue-based scaling model. The AI forecasting model can predict an estimated number of instances required, and if that prediction is wrong, because, for example, work requests are suddenly submitted in an out-of-pattern manner, a queue can start to grow, and the queue-based scaling model can determine an additional number of workers needed to handle the queue.

Advantages of the disclosed embodiments over the existing technology include but are not limited to improved computing resource utilization, as workers are started and/or stopped in a predictive, rather than reactive, manner. The advantages of the disclosed techniques also include improved computing resource utilization when work requests are received beyond that which was predicted by the machine learning model.

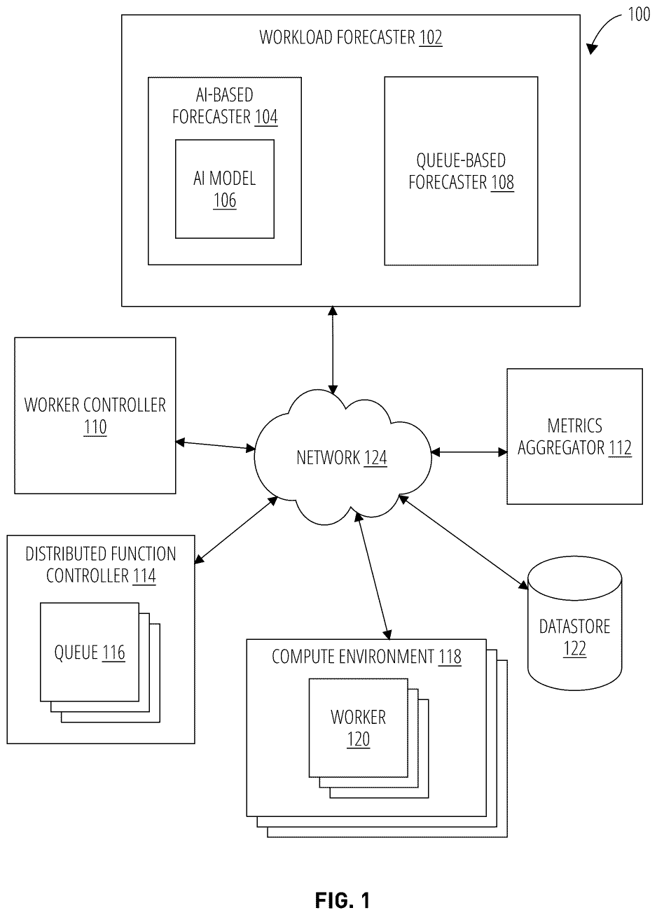

FIG. 1 is a block diagram of an example distributed workload system 100 for real-time forecasting and adaptive scaling of distributed workers using AI, according to at least one embodiment. Distributed workload system 100 can include workload forecaster 102, worker controller 110, metrics aggregator 112, distributed function controller 114, one or more compute environments 118, and datastore 122 connected to network 124. Network 124 can be a public network (e.g., the Internet), a private network (e.g., a local area network (LAN) or wide area network (WAN)), a wireless network, a personal area network (PAN), another network type, and/or a combination thereof. Workload forecaster 102, worker controller 110, metrics aggregator 112, and distributed function controller 114 may be components (e.g., software and/or hardware components) that are hosted by one or more machines such as server machines, client devices, etc.

A user (or an entity) can configure one or more distributed functions (e.g., “tasks”) that can be executed by a worker (e.g., worker 120) in a compute environment (e.g., compute environment 118). Each function (e.g., “task”) can have or is otherwise associated with a corresponding queue where work requests are received. One or more workers associated with the function can remove work requests from the queue, execute the work request, and return a result of the work request.

Workload forecaster 102 can generate one or more forecasts related to work requests and/or workers for various queues of tasks. In some embodiments, workload forecaster 102 can use AI-based forecaster 104 to generate one or more forecasts for the number of work requests that may be received for a particular function in a particular timeframe (e.g., in the next minute, in the next 30 minutes, in the next hour, in the next day, etc.). Based on the forecasted number of work requests that will be received, the number of workers that are available to handle the work requests can be scaled up or down (e.g., by worker controller 110).

More specifically, AI-based forecaster 104 may be configured to receive one or more metrics and predict the number of work requests that will be received at a particular time in the future for a particular function. In some embodiments, the metrics are collected by metrics aggregator 112. The metrics may be provided by one or more components of distributed workload system 100, such as individual workers 120, compute environments 118, worker controller 110, and distributed function controller 114. The metrics can include the number of work requests received in a predetermined duration (e.g., work requests received per second, work requests received per minutes, work requests received per 15 minutes, etc.), the resource (e.g., CPU, GPU, memory, network, etc.) utilization of a device and/or compute environment hosting a worker process, the amount of time it takes for a worker to process a work request, the amount of time it takes for a new worker to start up, and/or the like.

In some embodiments, metrics aggregator 112 stores the metrics in datastore 122. In some embodiments, the metrics include one or more identifiers (e.g., a tag, a category, an entity id, etc.) that can be used to group the metrics. For example, metrics aggregator 112 may be able to group metrics related to a particular compute environment, a particular distributed function, or a particular worker process. In some embodiments, metrics aggregator 112 can aggregate all of the metrics related to a particular user or entity. For example, a user or entity may be associated with a plurality of distributed functions (and their associated queues) that are run on a plurality of workers across a plurality of compute environments. In some cases, metrics aggregator 112 may provide metrics only associated with a particular user to AI-based forecaster 104 for generating work request predictions. In some cases, metrics aggregator 112 may provide metrics only associated with a particular compute environment of a particular user to AI-based forecaster 104.

Using metrics from metrics aggregator 112, AI-based forecaster 104 can generate a prediction of the number of work requests that will be received at a particular time in the future for a particular function. In some embodiments, the number of work requests that are expected to be received within (or at) a predetermined time in the future can be represented using a prediction function. The prediction function can include one or more weighted terms. In some embodiments, the terms can include one or more of the collected metrics, one or more autoregressive terms, and/or one or more Fourier series terms. For example, one or more of the Fourier series terms of the prediction function can be weighted sine and/or cosine functions.

AI-based forecaster 104 can include AI model 106 which can determine (e.g., “learn”) the optimal weight for each term of the prediction function. In some embodiments, AI model 106 can use an iterative process (e.g., gradual descent) to determine optimal weights. In some embodiments, AI model 106 can use a single iteration (e.g., using a linear regression algorithm) to determine optimal weights. For example, optimal weights can be determined using an ordinary least squares algorithm, a weighted least squares algorithm, a generalized least squares algorithm, a ridge regression algorithm, a lasso regression algorithm, and/or the like. Using the optimal weights and the prediction function, AI-based forecaster 104 can generate the predicted number of work requests. Because the optimal weights can be calculated in a single iteration, the weights can be updated quickly based on new metrics, allowing real-time (or near real-time) predictions of future numbers of work requests.

Based on the predicted number of work requests and the collected metrics, a number of workers needed at the future time for a particular function can be calculated. In some embodiments, workload forecaster 102 can calculate the number of workers needed at the future time. In some embodiments, the predicted number of work requests from AI-based forecaster 104 is provided to worker controller 110 and worker controller 110 calculates the number of workers needed at the future time.

In some embodiments, the number of workers needed at the future time can be calculated by multiplying the predicted number of work requests (or an average predicted number of work requests over a predetermined time period) by the amount of time required to respond to a work request (or an average amount of time required to respond to a work request). For example, the number of workers needed at the future time may be calculated based on Little's Law.

In some embodiments, the number of workers needed at the future time can be calculated based on an amount of time (e.g., the average amount of time) required to process a work request and the amount of time that is required to start new workers. The number of future workers needed can be calculated to balance the response latency (e.g., the amount of time required to respond to a work request) and the cost associated with the number of resources (e.g., GPU resources) consumed.

If the number of workers needed at the future time is more than the current number of workers, worker controller 110 can start additional workers to prepare for the predicted additional work requests. If the number of workers needed at the future time is less than the current number of workers, worker controller 110 can stop one or more workers to use fewer computing resources.

In some embodiments, the number of future workers needed can be calculated based on a minimum and/or maximum number of workers allowed by a user associated with the workers and/or distributed function. For example, the predicted number of work requests for a particular function may suggest that 2 workers will be needed at the future time to handle the incoming requests for the function. However, if the user that configured the function specified that at least 3 workers should always be available to handle requests, worker controller 110 may ignore the prediction and no workers may be removed. If there are more than 3 workers running at the time the prediction is received, worker controller 110 may remove one or more workers until there are 3 remaining. Thus, the number of workers may be modified in response to the prediction but may not exactly match the prediction.

As another example, the predicted number of work requests for a particular function may suggest that 10 workers will be needed at the future time to handle the incoming requests for the function. If the user that configured the function specified that no more than 8 workers should be running at any given time, worker controller 110 may ignore the prediction and no additional workers may be added. If there are less than 8 workers running at the time the prediction is received, worker controller 110 may add one or more workers until there are 8 running workers. Thus, the number of workers may be modified in response to the prediction but may not exactly match the prediction.

In some embodiments, the number of workers may be modified (e.g., workers may be started/stopped by worker controller 110) based on satisfaction of one or more criterion. For example, additional workers may only be started if the predicted number of worker requests exceeds a predetermined threshold. As another example, additional workers may only be started if current resource utilization metrics (e.g., CPU utilization, GPU utilization, etc.) exceed a predetermined upper threshold. In some embodiments, workers may only be stopped if current resource utilization metrics fall below a predetermined lower threshold.

For example, if the current resource utilization is within an average range (e.g., between 70% and 80%), worker controller 110 may not scale the number of workers (e.g., no workers may be started or stopped). If the current resource utilization is within a moderate high range (e.g., between 80% and 90%), the number of workers for a particular function may be adjusted (e.g., by adding/removing workers) to equal the maximum of the predicted number of workers needed and the current number of workers. If the current resource utilization is extremely high (e.g., greater than 90%), the number of workers for a particular function may be adjusted to equal the maximum of the predicted number of workers needed multiplied by a scaling-up factor and the current number of workers.

If the current resource utilization is within a moderate low range (e.g., between 50% and 70%), worker controller 110 may adjust the number of workers for a particular function to equal the minimum of the predicted number of workers needed and the current number of workers. If the current resource utilization is extremely low (e.g., less than 50%), the number of workers for a particular function may be adjusted to equal the minimum of the predicted number of workers needed multiplied by a scaling-down factor and the current number of workers.

In some embodiments, the resource utilization metrics are based on a user-defined level of concurrency and do not depend on the amount of computing resources (e.g., CPU, GPU, etc.) used. For example, a user may configure a worker to process up to 5 work requests simultaneously. If the worker is executing 1 work request, its utilization metric may be 20%. If the worker is executing 5 work requests, its utilization metric may be 100%, even if the CPU and/or GPU utilization metrics of the device hosting the worker are not 100%.

In some embodiments, the resource utilization metrics used to decide if workers should be started/stopped can include resource utilization metrics of one or more of the following: the device hosting the worker process, the computing environment hosting that device, all the devices associated with a particular function of a user, all the devices associated with a particular user, all the devices of the distributed workload system, etc.

In some embodiments, an additional value (e.g., a buffer amount) may be added to the predicted number of workers needed to reduce the chances a work request is received without a worker available to handle it. In some embodiments, the buffer amount for a particular function's workers prediction is determined based on a variability of the work request compute duration for the function. For example, if there is a lot of variability (e.g., more than 5% difference, more than 20% difference, more than 50% difference, etc.) in the amount of time needed to process work requests for a particular function, a larger buffer value may be added to the predicted number of workers.

In some embodiments, the buffer amount for a particular function's workers prediction is determined based on a variability of the number of incoming work requests for the function. For example, if the amount of work requests received for the function within a predetermined duration varies greatly (e.g., by more than 5%, by more than 15%, by more than 25%, etc.), a larger buffer value may be added to the predicted number of workers.

In some embodiments, workload forecaster 102 can use queue-based forecaster 108 to generate one or more forecasts for the number of additional workers that may be created to handle the work requests for a particular function based on a size of the queue related to the function. For example, if the number of work requests received at a particular time is different than the predicted number of work requests to be received at that time (e.g., because historical data has not been collected yet, causing the prediction to be incorrect; because the number of work requests is deviating from historical patterns; etc.), work requests can build up in a queue because there are not enough workers to process the requests. A new number of workers needed (e.g., a number of additional workers) can be determined using one or more algorithms based on a size of the queue. For example, an amount of excess work in the queue can be calculated based at least on 1) a current size of the queue, 2) an average time it takes for a worker to process a work request, and 3) the number of workers that are processing work requests or starting up.

If there is excess work in the queue, one or more workers can be started up based on a start-up time of the worker process. In some embodiments, worker controller 110 can determine the amount of time required to start up a new worker for a particular function. In some embodiments, an average amount of time required to start up a new worker for a particular function can be determined using metrics aggregator 112.

As an example, consider that there is 35 minutes of excess work in a queue (e.g., it will take 35 minutes for a single worker to process all the work in the queue) and that a new worker takes 15 minutes to start up. If one worker is added, it will take 50 minutes to clear the queue (15 minute startup+35 minutes of work). If two workers are added, they can start in parallel, and it will take about 33 minutes to clear the queue (15 minute startup+(35 minutes of work/2 workers)). If three workers are added, they can start in parallel, and it will take about 27 minutes to clear the queue (15 minute startup+(35 minutes of work/3 workers)).

In some embodiments, whenever there is a queue (e.g., whenever there are more work requests than can be handled by the existing workers), at least one workers can be added to reduce the size of the queue. Continuing the example from above, when adding the second worker process, the extra worker is blocked for 15 minutes during startup, but 17 minutes of time is saved overall, so it can be advantageous to add the second worker process. When adding the third worker process, the extra worker is blocked for 15 minutes, but only 6 minutes of time is saved overall, so it may not be advantageous to add the third worker process. Thus, queue-based forecaster 108 may determine it is best to start two additional workers and may communicate this to worker controller 110, which may cause the additional workers to be started.

In some embodiments, the number of additional workers to be added can be represented by the following formula:

$$\frac{q}{( n ) ( n + 1 )} = s$$

where q is the amount of excess work in the queue (e.g., the amount of time it would take for a single worker to process all the work requests in the queue), s is the startup time of a worker process, and n is the new number of additional workers that should be added. In some embodiments, n can be rounded up to the nearest whole number, and any negative solutions can be discarded.

In some embodiments, the amount of excess work in the queue (e.g., q) is determined based on a size of the queue, a work request compute duration (e.g., an average work request compute duration) for the task associated with the queue, and a number of workers for the task. In some embodiments, the number of workers for the task includes a first set of workers for the task in a ready state (e.g., workers that are ready to process (or are already processing) work requests) and a second set of workers for the task in a startup state (e.g., workers that are still starting up and are not yet ready to process work requests).

In some embodiments, q is further based on a rate of change of the size of the queue. For example, if metrics (e.g., from metrics aggregator 112) indicate that the size of the queue is growing, q may be larger than if the metrics indicate that the size of the queue is shrinking. In some embodiments, if the size of the queue is shrinking, there may be sufficient workers already and no additional workers may be added.

In some embodiments, q is the amount of excess work in the queue at a future time. For example, q may be the amount of time it would take for a single worker to process all the work requests that are expected to be in the queue in s time. In other words, q may be the amount of work in the queue that exceeds the current capacity of the workers for the task. The current capacity of the workers may include workers that are still starting-up. Thus, the amount of excess work in the queue may be determined using the following formula: (size of queue*work request compute duration)−(number of workers*number of work requests that a workers can simultaneously process*work request compute duration)+(expected growth of the queue size after s time).

Continuing the example from above and applying the above formula, the formula becomes

$$\frac{35}{( n ) ( n + 1 )} = 15 .$$

Solving for n gives: n≈−2.1, 1.1. Discarding the negative solution and rounding up gives n=2 as the number of additional workers that should be added to handle the excess work in the queue.

In some embodiments, a term k can be added to the formula to adjust the number of instances that are added based on an amount of currently available resources:

$$\frac{k q}{( n ) ( n + 1 )} = s$$

In some cases, k can be proportional to an amount of available resources. In some embodiments, the available resources can be based on resources of a device hosting a workers, resources of all devices and/or compute environments associated with a particular user or entity, and/or resources of all devices and/or compute environments associated with a distributed workload system.

As the number of available resources increases, k can increase, and vice versa. The value of k can represent what the ratio of the startup time of a workers compared to the time saved overall needs to be in order for an additional worker to be worthwhile. For example, when k=2, it may be worthwhile to add an additional worker with a startup time of 40 minutes if 20 minutes of time is saved overall

$$( e . g . , \frac{s}{saved time} = k ) .$$

In some embodiments, an additional worker efficiency value can be calculated for a particular task (e.g., distributed function). The additional worker efficiency value may indicate how beneficial adding an additional worker for a particular task would be. The additional worker efficiency value may be calculated for a particular task by dividing the queue time 9 of the task by the startup time s of workers for the task. It may be more efficient (e.g., a better use of resources, may quickly reduce queue sizes overall, etc.) to add workers to a task with a higher additional worker efficiency value than a task with a lower additional worker efficiency value.

For example, if a first task has a queue time of 30 and a startup time of 15, the additional worker efficiency value for the first task may be 2. If a second task has a queue time of 20 and a startup time of 40, the additional worker efficiency value for the second task may be 0.5. If there are limited resources available for adding additional workers, it can be advantageous to add the additional worker for the first task since its additional worker efficiency value (2) is higher than the additional worker efficiency value (0.5) of the second task.

In some embodiments, workload forecaster 102 can use AI-based forecaster 104 and queue-based forecaster 108 at the same time. For example, AI-based forecaster 104 can predict an estimated number of instances required based on patterns in historical data (e.g., based on metrics from metrics aggregator 112). If that prediction is wrong, because, for example, work requests are suddenly submitted in an out-of-pattern manner, a queue can start to grow. Queue-based forecaster 108 can then determine an additional number of workers needed to handle the queue.

Distributed function controller 114 may manage one or more distributed functions and their associated work request queues. For example, a user or entity may register a distributed function with distributed function controller 114. Distributed function controller 114 may create one or more queues 116 for the distributed function (e.g., a work request queue, a work response queue, etc.) and may cause worker controller 110 to create one or more workers (e.g., in compute environment 118) to handle work requests for the distributed function.

In some embodiments, a work request can include a distributed function identifier and one or more input values that should be provided to the distributed function. In some embodiments, one or more distributed functions managed by distributed function controller 114 use AI model(s) to perform inferencing tasks on the input value(s) in a work request.

As work requests are submitted to distributed function controller 114, each work request may be stored in a queue 116 associated with the distributed function identified in the work request. One or more workers 120 associated with the distributed function may retrieve work requests from the queue 116 associated with the distributed function and may execute the distributed function based on the input value(s) included in the work request. In some embodiments, workers 120 provide a result of the distributed function execution to another queue 116 (e.g., a work response queue associated with the distributed function) of distributed function controller 114.

Compute environments 118 can include one or more execution environments for workers 120 associated with distributed functions of distributed workload system 100. For example, compute environments 118 can include one or more cloud service provider environments, private datacenter environment, and/or the like. Each compute environment 118 can include one or more workers 120. Each worker 120 can include one or more processes executing within and using the compute resources of the compute environment 118 hosting the worker process. Compute environment 118 can also compute resources (not shown), such as processing units, networking interfaces, memory, and/or the like. In some embodiments, the processing units include one or more central processing units (CPUs), graphics processing units (GPUs), data process units (DPUs), parallel processing units, and/or the like. Workers 120 deployed within compute environment 118 can use the compute resources of compute environment 118 for execution of distributed functions.

As discussed above, worker controller 110 may manage the workers 120 deployed within compute environments 118. For example, worker controller 110 may start and/or stop workers for a particular distributed function based on one or more values (e.g., predictions) from workload forecaster 102. In some embodiments, worker controller 110 may create workers when a distributed function is registered with distributed function controller 114.

Datastore 122 can include a persistent storage capable of storing metrics, distributed function information, worker information, machine learning models and/or machine learning model parameters, compute environment information, executable code, distributed function inputs, distributed function outputs, and/or the like. Datastore 122 can be hosted by one or more storage devices, such as main memory, magnetic or optical storage disks, tapes, or hard drives, network-attached storage (NAS), storage area network (SAN), and so forth. Although depicted as separate from metrics aggregator 112, in at least some embodiments, datastore 122 can be a part of metrics aggregator 112. In at least some embodiments, datastore 122 can include a network-attached file server, while in other embodiments, datastore 122 can include some other type of persistent storage such as an object-oriented database, a relational database, a vector database, an in-memory database, and so forth, that may be hosted by a server machine or one or more different machines coupled to metrics aggregator 112 via network 124.

In some embodiments, workers 120 may provide metrics to datastore 122 for storage. In some embodiments, workers 120 may provide metrics to metrics aggregator 112 for storage in datastore 122. In some embodiments, worker controller 110 may use datastore 122 for storing worker information. In some embodiments, distributed function controller 114 may use datastore 122 for storing queue information and/or distributed function information. In some embodiments, AI-based forecaster 104 may use datastore 122 to store one or more machine learning model weights and/or parameters.

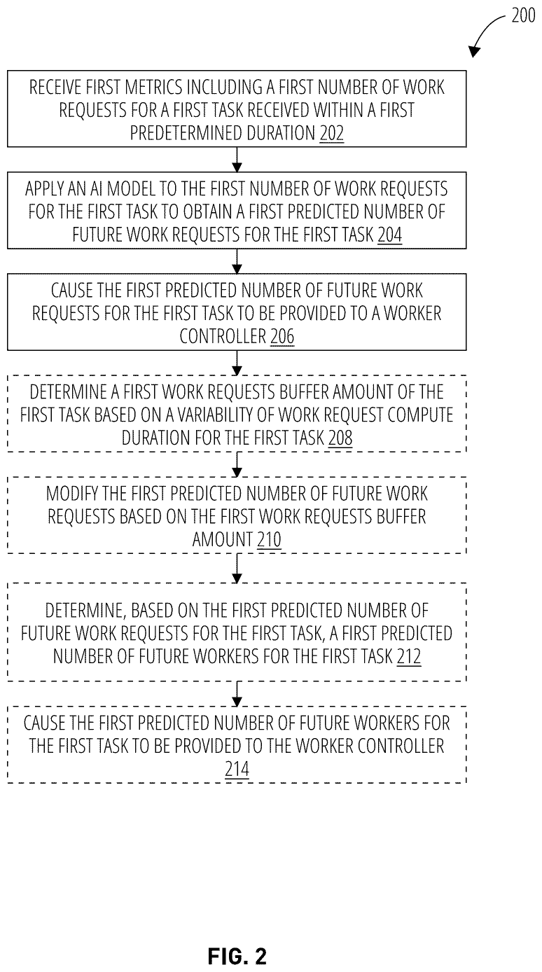

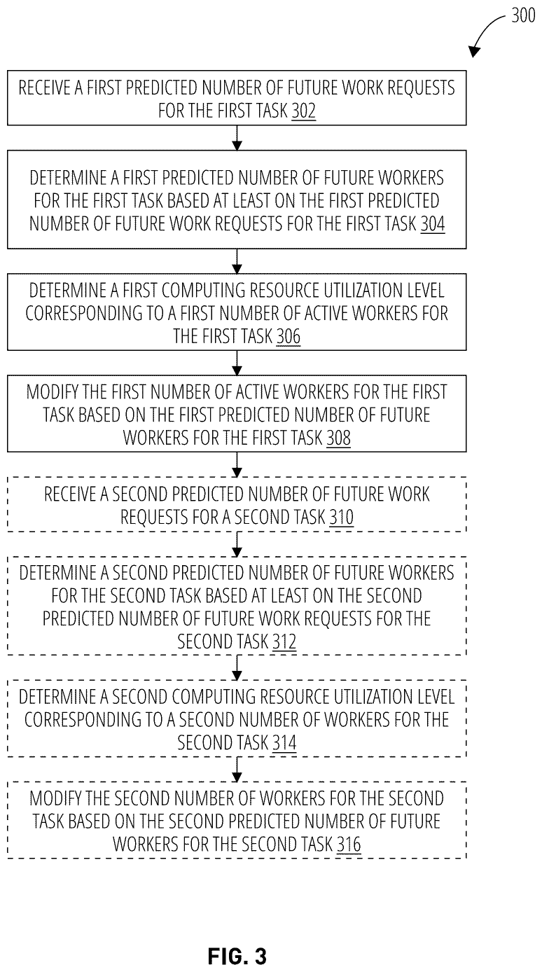

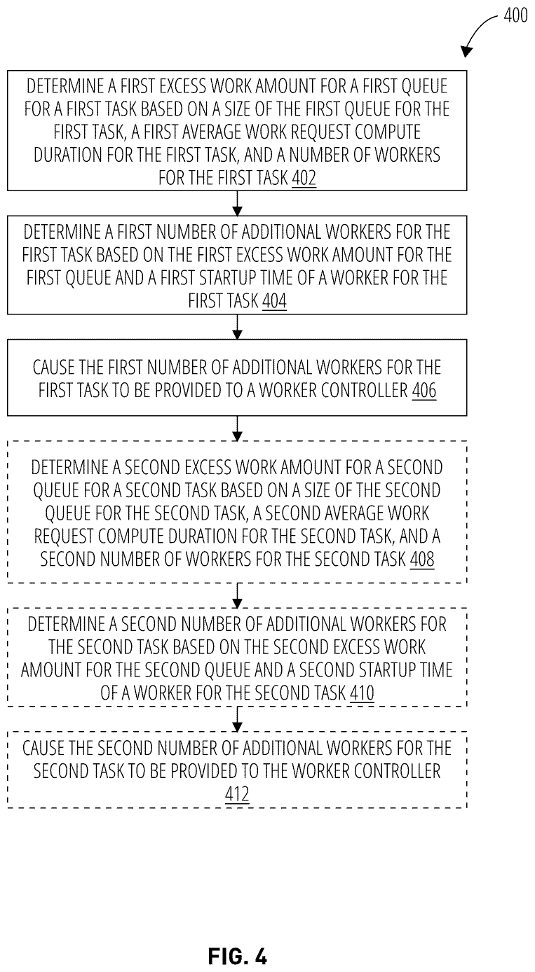

FIG. 2 is a flow diagram of an example method 200 for forecasting work requests using artificial intelligence, according to at least one embodiment. FIG. 3 is a flow diagram of an example method 300 for real-time forecasting and adaptive scaling of distributed workers using AI, according to at least one embodiment. FIG. 4 is a flow diagram of an example method 400 for forecasting additional workers using queue sizes, according to at least one embodiment.

Methods 200, 300, and/or 400 can be performed using one or more processing units (e.g., CPUs, GPUs, accelerators, physics processing units (PPUs), data processing units (DPUs), parallel processing units, etc.), which may include (or communicate with) one or more memory devices. In at least one embodiment, methods 200, 300, and/or 400 can be performed using a processing device or processing devices. In at least one embodiment, methods 200 and/or 400 can be performed using processing units of workload forecaster 102 of FIG. 1. In at least one embodiment, method 300 can be performed by worker controller 110 of FIG. 1. In at least one embodiment, processing units performing any of methods 200, 300, and/or 400 can be executing instructions stored on a non-transient computer readable storage media. In at least one embodiment, any of methods 200, 300, and/or 400 can be performed using multiple processing threads (e.g., CPU threads and/or GPU threads), individual threads executing one or more individual functions, routines, subroutines, or operations of the method. In at least one embodiment, processing threads implementing any of methods 200, 300, and/or 400 can be synchronized (e.g., using semaphores, critical sections, and/or other thread synchronization mechanisms). Alternatively, processing threads implementing any of methods 200, 300, and/or 400 can be executed asynchronously with respect to each other. Various operations of methods 200, 300, and/or 400 can be performed in a different order compared with the order shown in FIG. 2, FIG. 3, and FIG. 4. Some operations of any of methods 200, 300, and/or 400 can be performed concurrently with other operations. In at least one embodiment, one or more operations shown in FIG. 2, FIG. 3, and/or FIG. 4 may not always be performed.

Referring to FIG. 2, at block 202, processing units executing method 200 can receive first metrics including a first number of work requests for a first task received within a first predetermined duration. At block 204, processing units can apply an AI model to the first number of work requests for the first task to obtain a first predicted number of future work requests for the first task. In some embodiments, the AI model includes a prediction function including one or more autoregressive terms and one or more Fourier series terms. In some embodiments, the one or more autoregressive terms and/or the one or more Fourier series terms have corresponding weights. The AI model may be trained to determine weights that minimize a difference between the first predicted number of future work requests for the first task and a ground truth number of work requests.

At block 206, processing units can cause the first predicted number of future work requests for the first task to be provided to a worker controller for managing a first plurality of workers deployed within a first compute environment to execute the first task.

In some embodiments, at block 208, processing units may determine a first work requests buffer amount of the first task based on a variability of work request compute duration for the first task. For example, if the amount of time required to execute a work request (e.g., the work request compute duration) for the first task varies greatly (e.g., by more than 5%, by more than 20%, by more than 50%, etc.), the first work requests buffer amount may be large (e.g., 10% of the first predicted number of future work requests, 20% of the first predicted number of future work requests, 60% of the first predicted number of future work requests, etc.).

At block 210, processing units may modify the first predicted number of future work requests based on the first work requests buffer amount.

In some embodiments, at block 212, processing units may determine, based on the first predicted number of future work requests for the first task, a first predicted number of future workers for the first task. In some embodiments, the first metrics further include a first average work request compute duration, and, as described above, the first predicted number of future workers can be calculated by multiplying the first predicted number of future work requests (or an average predicted number of work requests over a predetermined time period) by the amount of time required to respond to a work request (e.g., work request compute duration) (or an average work request compute duration). For example, the first predicted number of future workers may be calculated based on Little's Law.

At block 214, the processing units may cause the first predicted number of future workers for the first task to be provided to the worker controller for managing the first plurality of workers deployed within the first compute environment to execute the first task.

In some embodiments, processing units may receive second metrics including a second number of work requests for a second task (e.g., a second distributed function) received within a second predetermined duration. The processing units may apply the AI model to the second number of work requests for the second task to obtain a second predicted number of future work requests for the second task. In some embodiments, a second AI model is used to obtain the second predicted number of future work requests for the second task. The second AI model may be trained based on metrics associated with the second task, whereas the first AI model may be trained based on metrics associated with the first task.

The processing units may further cause the second predicted number of future work requests for the second task to be provided to the worker controller for managing a second plurality of workers deployed within a second compute environment to execute the second task. In some embodiments, the processing units may determine, based on the second predicted number of future work requests for the second task, a second predicted number of future workers for the second task. The processing units may cause the second predicted number of future workers for the second task to be provided to the worker controller for managing the second plurality of workers deployed within the second compute environment to execute the second task.

In some embodiments, the second metrics may include a second average work request compute duration, which may be different than the first average work request compute duration. The processing units may determine the second predicted number of future workers for the second task further based on the second average work request compute duration for the second task.

Referring to FIG. 3, at block 302, processing units executing method 300 can receive, at a worker controller managing ongoing allocation of workers for a first task, a first predicted number of future work requests for the first task. In some embodiments, the first predicted number of future work requests is determined using an AI model and metrics related to work requests received for the first task.

At block 304, processing units may determine a first predicted number of future workers for the first task based at least on the first predicted number of future work requests for the first task. In some embodiments, the first predicted number of future workers for the first task is further based on a first average work request compute duration for the first task. In some embodiments, the first predicted number of future workers for the first task is based on a queue size of a queue associated with the first task. In some embodiments, processing units may receive the first predicted number of future workers for the first task.

At block 306, processing units may determine a first computing resource utilization level corresponding to a first number of active workers for the first task.

At block 308, processing units may modify the first number of active workers for the first task based on the first predicted number of future workers for the first task. In some embodiments, modifying the first number of active workers for the first task is performed responsive to the first computing resource utilization level satisfying a load criterion.

In some embodiments, the load criterion includes a scaling-up threshold (e.g., a first threshold), and the first number of active workers for the first task may be increased based on the first predicted number of future workers for the first task responsive to the first computing resource utilization level exceeding the scaling-up threshold.

In some embodiments, the load criterion includes a scaling-down threshold (e.g., a second threshold), and the first number of active workers for the first task may be decreased based on the first predicted number of future workers for the first task responsive to the first computing resource utilization level falling below the scaling-down threshold.

In some embodiments, the first computing resource utilization level is based on metrics aggregated from one or more computing environments hosting the first number of active workers for the first task.

In some embodiments, at block 310, processing units may receive a second predicted number of future work requests for a second task. At block 312, processing units may determine a second predicted number of future workers for the second task based at least on the second predicted number of future work requests for the second task. At block 314, processing units may determine a second computing resource utilization level corresponding to a second number of workers for the second task.

At block 316, processing units may modify the second number of workers for the second task based on the second predicted number of future workers for the second task. In some embodiments, modifying the second number of workers is performed responsive to the second computing resource utilization level satisfying the load criterion. In some embodiments, modifying the first number of active workers is performed responsive to the first computing resource utilization level satisfying a first load criterion and modifying the second number of workers is performed responsive to the second computing resource utilization level satisfying a second load criterion.

Referring to FIG. 4, at block 402, processing units executing method 400 can determine a first excess work amount for a first queue for a first task based on a size of the first queue for the first task, a first average work request compute duration for the first task, and a number of workers for the first task. In some embodiments, the first excess work amount for the first queue for the first task is based on a single work request compute duration for the first task instead of an average work request compute duration for the first task.

In some embodiments, the first excess work amount for the first queue for the first task is further based on a first rate of change of the size of the first queue for the first task.

In some embodiments, the first number of workers for the first task includes a first set of workers for the first task in a ready state and a first set of workers for the first task in a startup state.

At block 404, processing units can determine a first number of additional workers for the first task based on the first excess work amount for the first queue and a first startup time of a worker of the first task.

In some embodiments, the first number of additional workers for the first task is further based on a resource availability of a device hosting one or more workers. In some embodiments, the first number of additional workers for the first task is further based on a resource availability of computing environments and/or computing resources associated with a particular user or entity. In some embodiments, the first number of additional workers for the first task is further based on a resource availability of one or more computing environments of a distributed workload system that includes the first number of workers for the first task.

At block 406, processing units can cause the first number of additional workers for the first task to be provided to a worker controller for managing a first plurality of workers deployed within a first compute environment to execute the first task.

In some embodiments, at block 408, processing units can determine a second excess work amount for a second queue for a second task based on a size of the second queue for the second task, a second average work request compute duration for the second task, and a second number of workers for the second task. In some embodiments, the second excess work amount for the second queue for the second task is based on a single work request compute duration for the second task instead of an average work request compute duration for the second task.

At block 410, processing units can determine a second number of additional workers for the second task based on the second excess work amount for the second queue and a second startup time of a worker of the second task.

At block 412, processing units can cause the second number of additional workers for the second task to be provided to the worker controller for managing a second plurality of workers deployed within a second compute environment to execute the second task.

In some embodiments, processing units can determine a first additional worker efficiency value for the first task based on the size of the first queue for the first task and the first startup time of a worker for the first task. Processing units can also determine a second additional worker efficiency value for the second task based on the size of the second queue for the second task and the second startup time of a worker for the second task. Causing the second number of additional workers for the second task to be provided to the worker controller may be based on the second additional worker efficiency value being higher than the first additional worker efficiency value. For example, if it is more efficient to add additional workers for the second task than adding additional workers for the first task, the additional number of workers for the second task may be provided to the worker controller.

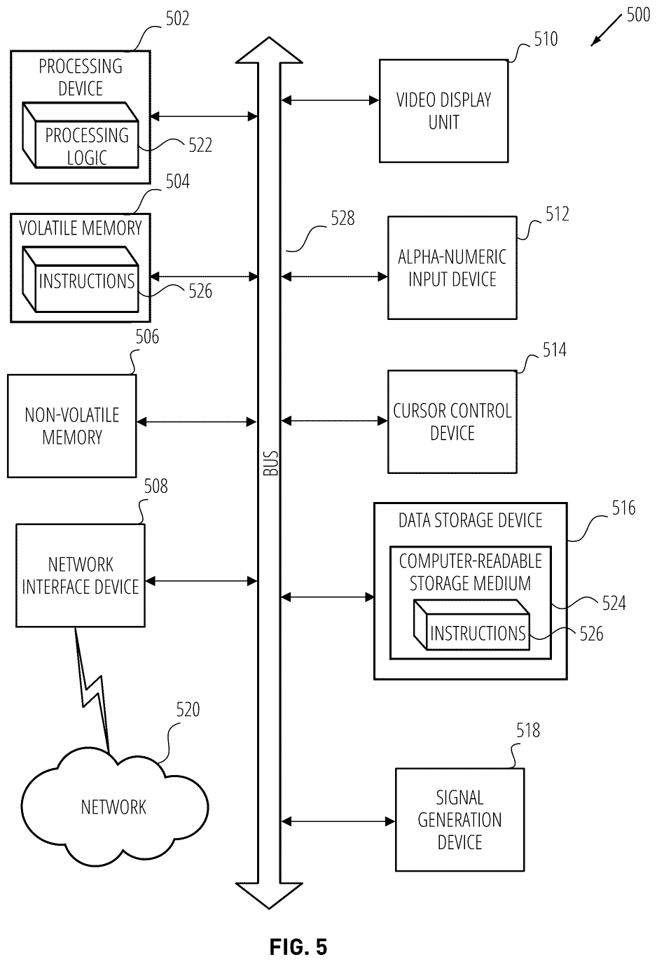

FIG. 5 is a block diagram illustrating an exemplary computer system, in accordance with at least one embodiment of the present disclosure. The computer system 500 can correspond to workload forecaster 102, worker controller 110, metrics aggregator 112, distributed function controller 114, and/or compute environment 118 described with respect to FIG. 1. Computer system 500 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 516, which communicate with each other via a bus 528.

Processor (processing device) 502 represents one or more general-purpose processing devices such as a microprocessor, central processing unit, or the like, and may include processing logic 522. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 526 (e.g., for generating threat indicator alerts) for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 518 (e.g., a speaker). In some embodiments, computer system 500 may not include video display unit 510, input device 512, and/or cursor control device 514 (e.g., in a headless configuration).

The data storage device 516 can include a non-transitory machine-readable storage medium 524 (also computer-readable storage medium) on which is stored one or more sets of instructions 526 (e.g., for real-time forecasting and adaptive scaling of distributed workers using AI) embodying any one or more of the methodologies or functions described herein. The instructions 526 can also reside, completely or at least partially, within the main memory 504 and/or within the processor 502 during execution thereof by the computer system 500, the main memory 504 and the processor 502 also constituting machine-readable storage media. The instructions can further be transmitted or received over a network 520 via the network interface device 508.

In one implementation, the instructions 526 include instructions for real-time forecasting and adaptive scaling of distributed workers using AI. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

### Inference and Training Logic

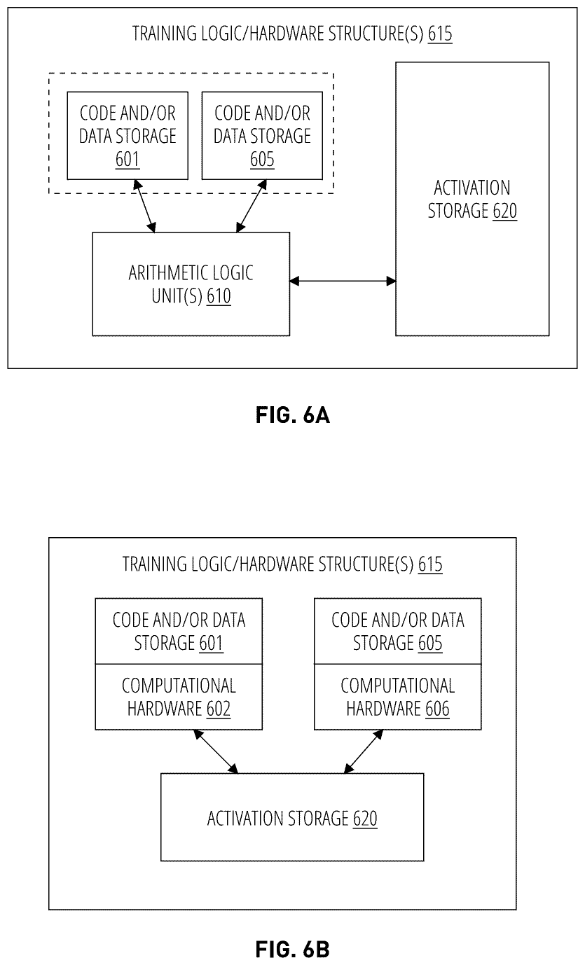

FIG. 6A illustrates inference and/or training logic 615 used to perform inferencing and/or training operations associated with one or more embodiments.

In at least one embodiment, inference and/or training logic 615 may include, without limitation, code and/or data storage 601 to store forward and/or output weight and/or input/output data, and/or other parameters to configure neurons or layers of a neural network trained and/or used for inferencing in aspects of one or more embodiments. In at least one embodiment, training logic 615 may include (or be coupled to code and/or data storage 601 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 601 may be included with other on-chip or off-chip data storage, including a processor's L1, L2, or L3 cache or system memory.

In at least one embodiment, any portion of code and/or data storage 601 may be internal or external to one or more processors or other hardware logic devices or circuits. In at least one embodiment, code and/or data storage 601 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 601 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 may include, without limitation, a code and/or data storage 605 to store backward and/or output weight and/or input/output data corresponding to neurons or layers of a neural network trained and/or used for inferencing in aspects of one or more embodiments. In at least one embodiment, code and/or data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 615 may include (or be coupled to code and/or data storage 605 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 605 may be included with other on-chip or off-chip data storage, including a processor's L1, L2, or L3 cache or system memory. In at least one embodiment, any portion of code and/or data storage 605 may be internal or external to one or more processors or other hardware logic devices or circuits. In at least one embodiment, code and/or data storage 605 may be cache memory, DRAM, SRAM, non-volatile memory (e.g., flash memory), or other storage. In at least one embodiment, a choice of whether code and/or data storage 605 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 601 and code and/or data storage 605 may be separate storage structures. In at least one embodiment, code and/or data storage 601 and code and/or data storage 605 may be a combined storage structure. In at least one embodiment, code and/or data storage 601 and code and/or data storage 605 may be partially combined and partially separate. In at least one embodiment, any portion of code and/or data storage 601 and code and/or data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 620 that are functions of input/output and/or weight parameter data stored in code and/or data storage 601 and/or code and/or data storage 605. In at least one embodiment, activations stored in activation storage 620 are generated according to linear algebraic and/or matrix-based mathematics performed by ALU(s) 610 in response to performing instructions or other code, wherein weight values stored in code and/or data storage 605 and/or code and/or data storage 601 are used as operands along with other values, such as bias values, gradient information, momentum values, or other parameters or hyperparameters, any or all of which may be stored in code and/or data storage 605 or code and/or code and/or data storage 601 or another storage on or off-chip.

In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALU(s) 610 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 601, code and/or data storage 605, and activation storage 620 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., flash memory), or other storage. In at least one embodiment, activation storage 620 may be completely or partially within or external to one or more processors or other logical circuits. In at least one embodiment, a choice of whether activation storage 620 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 illustrated in FIG. 6A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, code and/or data storage 601 and code and/or data storage 605, which may be used to store code (e.g., graph code), weight values and/or other information, including bias values, gradient information, momentum values, and/or other parameter or hyperparameter information. In at least one embodiment illustrated in FIG. 6B, each of code and/or data storage 601 and code and/or data storage 605 is associated with a dedicated computational resource, such as computational hardware 602 and computational hardware 606, respectively. In at least one embodiment, each of computational hardware 602 and computational hardware 606 comprises one or more ALUs that perform mathematical functions, such as linear algebraic functions, only on information stored in code and/or data storage 601 and code and/or data storage 605, respectively, the result of which is stored in activation storage 620.

In at least one embodiment, each of code and/or data storage 601 and 605 and corresponding computational hardware 602 and 606, respectively, correspond to different layers of a neural network, such that resulting activation from one storage/computational pair 601/602 of code and/or data storage 601 and computational hardware 602 is provided as an input to a next storage/computational pair 605/606 of code and/or data storage 605 and computational hardware 606, in order to mirror a conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage/computation pairs 601/602 and 605/606 may be included in inference and/or training logic 615.

### Neural Network Training and Deployment

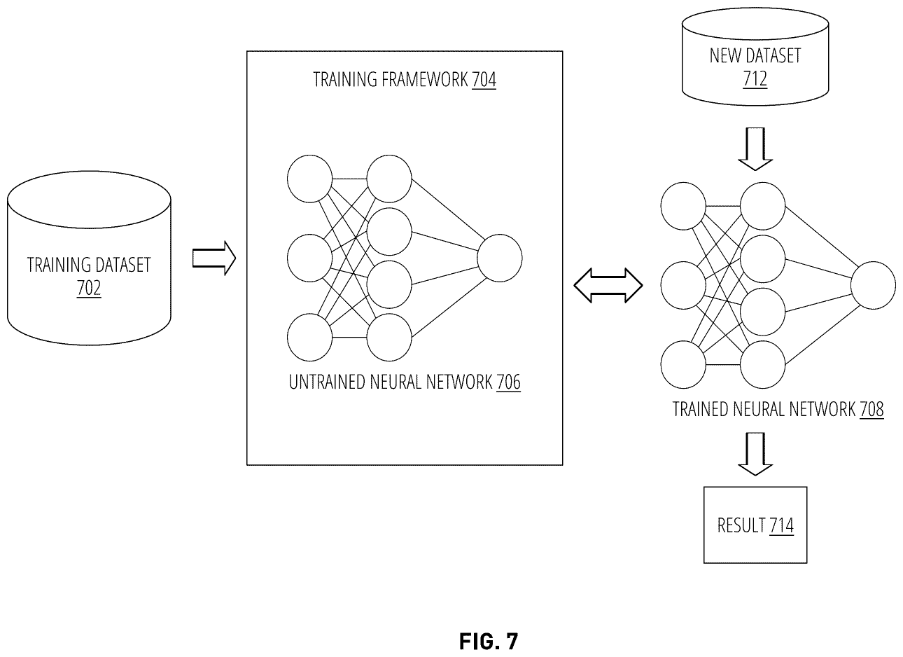

FIG. 7 illustrates training and deployment of a deep neural network, according to at least one embodiment. In at least one embodiment, untrained neural network 706 is trained using a training dataset 702. In at least one embodiment, training framework 704 is a PyTorch framework, whereas in other embodiments, training framework 704 is a TensorFlow, Boost, Caffe, Microsoft Cognitive Toolkit/CNTK, MXNet, Chainer, Keras, Deeplearning4j, or other training framework. In at least one embodiment, training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or un supervised manner.

In at least one embodiment, untrained neural network 706 is trained using supervised learning, wherein training dataset 702 includes an input paired with a desired output for an input, or where training dataset 702 includes input having a known output and an output of neural network 706 is manually graded. In at least one embodiment, untrained neural network 706 is trained in a supervised manner and processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on input data such as a new dataset 712. In at least one embodiment, training framework 704 trains untrained neural network 706 repeatedly while adjusting weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map in trained neural network 708 capable of performing operations useful in reducing dimensionality of new dataset 712. In at least one embodiment, unsupervised training can also be used to perform anomaly detection, which allows identification of data points in new dataset 712 that deviate from normal patterns of new dataset 712.

In at least one embodiment, semi-supervised learning may be used, which is a technique in which training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new dataset 712 without forgetting knowledge instilled within trained neural network 708 during initial training.

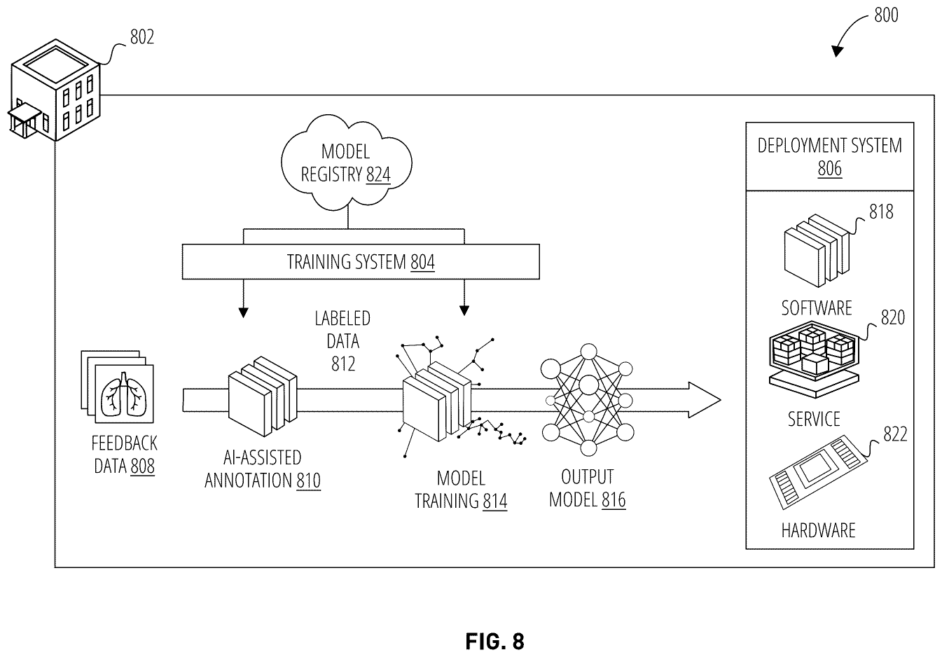

With reference to FIG. 8, FIG. 8 is an example data flow diagram for a process 800 of generating and deploying a processing and inferencing pipeline, according to at least one embodiment. In at least one embodiment, process 800 may be deployed to perform game name recognition analysis and inferencing on user feedback data at one or more facilities 802, such as a data center.

In at least one embodiment, process 800 may be executed within a training system 804 and/or a deployment system 806. In at least one embodiment, training system 804 may be used to perform training, deployment, and embodiment of machine learning models (e.g., neural networks, object detection algorithms, computer vision algorithms, etc.) for use in deployment system 806. In at least one embodiment, deployment system 806 may be configured to offload processing and compute resources among a distributed computing environment to reduce infrastructure requirements at facility 802. In at least one embodiment, deployment system 806 may provide a streamlined platform for selecting, customizing, and implementing virtual instruments for use with computing devices at facility 802. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 806 during execution of applications.

In at least one embodiment, some applications used in advanced processing and inferencing pipelines may use machine learning models or other AI to perform one or more processing steps. In at least one embodiment, machine learning models may be trained at facility 802 using feedback data 808 (such as imaging data) stored at facility 802 or feedback data 808 from another facility or facilities, or a combination thereof. In at least one embodiment, training system 804 may be used to provide applications, services, and/or other resources for generating working, deployable machine learning models for deployment system 806.

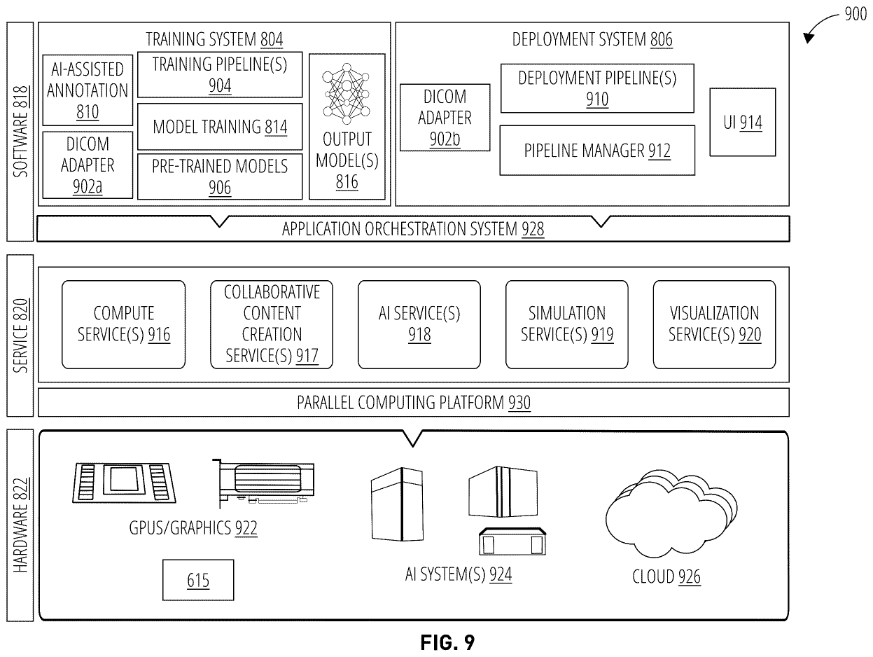

In at least one embodiment, a model registry 824 may be backed by object storage that may support versioning and object metadata. In at least one embodiment, object storage may be accessible through, for example, a cloud storage (e.g., a cloud 926 of FIG. 9) compatible application programming interface (API) from within a cloud platform. In at least one embodiment, machine learning models within model registry 824 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 904 (FIG. 9) may include a scenario where facility 802 is training their own machine learning model or has an existing machine learning model that needs to be optimized or updated. In at least one embodiment, feedback data 808 may be received from various channels, such as forums, web forms, or the like. In at least one embodiment, once feedback data 808 is received, AI-assisted annotation 810 may be used to aid in generating annotations corresponding to feedback data 808 to be used as ground truth data for a machine learning model. In at least one embodiment, AI-assisted annotation 810 may include one or more machine learning models (e.g., convolutional neural networks (CNNs)) that may be trained to generate annotations corresponding to certain types of feedback data 808 (e.g., from certain devices) and/or certain types of anomalies in feedback data 808. In at least one embodiment, AI-assisted annotations 810 may then be used directly, or may be adjusted or fine-tuned using an annotation tool, to generate ground truth data. In at least one embodiment, in some examples, labeled data 812 may be used as ground truth data for training a machine learning model. In at least one embodiment, AI-assisted annotations 810, labeled data 812, or a combination thereof may be used as ground truth data for training a machine learning model, e.g., via model training 814 in FIG. 8 and/or FIG. 9. In at least one embodiment, a trained machine learning model may be referred to as an output model 816, and may be used by deployment system 806, as described herein.

In at least one embodiment, training pipeline(s) 904 (FIG. 9) may include a scenario where facility 802 needs a machine learning model for use in performing one or more processing tasks for one or more applications in deployment system 806, but facility 802 may not currently have such a machine learning model (or may not have a model that is optimized, efficient, or effective for such purposes). In at least one embodiment, an existing machine learning model may be selected from model registry 824. In at least one embodiment, model registry 824 may include machine learning models trained to perform a variety of different inference tasks on imaging data. In at least one embodiment, machine learning models in model registry 824 may have been trained on imaging data from different facilities than facility 802 (e.g., facilities that are remotely located). In at least one embodiment, machine learning models may have been trained on imaging data from one location, two locations, or any number of locations. In at least one embodiment, when being trained on imaging data, which may be a form of feedback data 808, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 824. In at least one embodiment, a machine learning model may then be retrained, or updated, at any number of other facilities, and a retrained or updated model may be made available in model registry 824. In at least one embodiment, a machine learning model may then be selected from model registry 824—and referred to as output model(s) 816—and may be used in deployment system 806 to perform one or more processing tasks for one or more applications of a deployment system.

In at least one embodiment, training pipeline(s) 904 (FIG. 9) may be used in a scenario that includes facility 802 requiring a machine learning model for use in performing one or more processing tasks for one or more applications in deployment system 806, but facility 802 may not currently have such a machine learning model (or may not have a model that is optimized, efficient, or effective for such purposes). In at least one embodiment, a machine learning model selected from model registry 824 might not be fine-tuned or optimized for feedback data 808 generated at facility 802 because of differences in populations, genetic variations, robustness of training data used to train a machine learning model, diversity in anomalies of training data, and/or other issues with training data. In at least one embodiment, AI-assisted annotation 810 may be used to aid in generating annotations corresponding to feedback data 808 to be used as ground truth data for retraining or updating a machine learning model. In at least one embodiment, labeled data 812 may be used as ground truth data for training a machine learning model. In at least one embodiment, retraining or updating a machine learning model may be referred to as model training 814. In at least one embodiment, model training 814 may include data—e.g., AI-assisted annotations 810, labeled data 812, or a combination thereof—that may be used as ground truth data for retraining or updating a machine learning model.

In at least one embodiment, deployment system 806 may include software 818, service 820, hardware 822, and/or other components, features, and functionality. In at least one embodiment, deployment system 806 may include a software “stack,” such that software 818 may be built on top of service 820 and may use service 820 to perform some or all of processing tasks, and service 820 and software 818 may be built on top of hardware 822 and use hardware 822 to execute processing, storage, and/or other compute tasks of deployment system 806.

In at least one embodiment, software 818 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 808 (or other data types, such as those described herein). In at least one embodiment, an advanced processing and inferencing pipeline may be defined based on selections of different containers that are desired or required for processing feedback data 808, in addition to containers that receive and configure imaging data for use by each container and/or for use by facility 802 after processing through a pipeline (e.g., to convert outputs back to a usable data type for storage and display at facility 802). In at least one embodiment, a combination of containers within software 818 (e.g., that make up a pipeline) may be referred to as a virtual instrument (as described in more detail herein), and a virtual instrument may leverage service 820 and hardware 822 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 816 of training system 804.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 824 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 820 as a system (e.g., system 900 of FIG. 9). In at least one embodiment, once validated by system 900 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 900 of FIG. 9). In at least one embodiment, completed and validated applications or containers may be stored in a container registry and associated machine learning models may be stored in model registry 824. In at least one embodiment, a requesting entity that provides an inference or image processing request may browse a container registry and/or model registry 824 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 806 (e.g., a cloud) to perform processing of a data processing pipeline. In at least one embodiment, processing by deployment system 806 may include referencing selected elements (e.g., applications, containers, models, etc.) from a container registry and/or model registry 824. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 820 may be leveraged. In at least one embodiment, service 820 may include compute services, collaborative content creation services, simulation services, artificial intelligence (AI) services, visualization services, and/or other service types. In at least one embodiment, service 820 may provide functionality that is common to one or more applications in software 818, so functionality may be abstracted to a service that may be called upon or leveraged by applications. In at least one embodiment, functionality provided by service 820 may run dynamically and more efficiently, while also scaling well by allowing applications to process data in parallel, e.g., using a parallel computing platform 930 (FIG. 9). In at least one embodiment, rather than each application that shares a same functionality offered by a service 820 being required to have a respective instance of service 820, service 820 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 820 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 818 implementing advanced processing and inferencing pipeline may be streamlined because each application may call upon the same inference service to perform one or more inferencing tasks.

In at least one embodiment, hardware 822 may include GPUs, CPUs, data processing units (DPUs), an AI/deep learning system (e.g., an AI supercomputer, such as NVIDIA's DGX™ supercomputer system), a cloud platform, or a combination thereof. In at least one embodiment, different types of hardware 822 may be used to provide efficient, purpose-built support for software 818 and service 820 in deployment system 806. In at least one embodiment, use of GPU processing may be implemented for processing locally (e.g., at facility 802), within an AI/deep learning system, in a cloud system, and/or in other processing components of deployment system 806 to improve efficiency, accuracy, and efficacy of game name recognition.

In at least one embodiment, software 818 and/or service 820 may be optimized for GPU processing with respect to deep learning, machine learning, and/or high-performance computing, simulation, and visual computing, as non-limiting examples. In at least one embodiment, at least some of the computing environment of deployment system 806 and/or training system 804 may be executed in a datacenter or one or more supercomputers or high performance computing systems, with GPU-optimized software (e.g., hardware and software combination of NVIDIA's DGX™ system). In at least one embodiment, hardware 822 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 9 is a system diagram for an example system 900 for generating and deploying a deployment pipeline, according to at least one embodiment. In at least one embodiment, system 900 may be used to implement process 800 of FIG. 8 and/or other processes including advanced processing and inferencing pipelines. In at least one embodiment, system 900 may include training system 804 and deployment system 806. In at least one embodiment, training system 804 and deployment system 806 may be implemented using software 818, services 820, and/or hardware 822, as described herein.

In at least one embodiment, system 900 (e.g., training system 804 and/or deployment system 806) may implemented in a cloud computing environment (e.g., using cloud 926). In at least one embodiment, system 900 may be implemented locally with respect to a facility, or as a combination of both cloud and local computing resources. In at least one embodiment, access to APIs in cloud 926 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 900, may be restricted to a set of public internet service providers (ISPs) that have been vetted or authorized for interaction.

In at least one embodiment, various components of system 900 may communicate between and among one another using any of a variety of different network types, including but not limited to local area networks (LANs) and/or wide area networks (WANs) via wired and/or wireless communication protocols. In at least one embodiment, communication between facilities and components of system 900 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 804 may execute training pipelines 904, similar to those described herein with respect to FIG. 8. In at least one embodiment, where one or more machine learning models are to be used in deployment pipeline(s) 910 by deployment system 806, training pipeline(s) 904 may be used to train or retrain one or more (e.g., pre-trained) models, and/or implement one or more of pre-trained models 906 (e.g., without a need for retraining or updating). In at least one embodiment, as a result of training pipeline(s) 904, output model(s) 816 may be generated. In at least one embodiment, training pipeline(s) 904 may include any number of processing steps, AI-assisted annotation 810, labeling or annotating of feedback data 808 to generate labeled data 812, model selection from a model registry, model training 814, training, retraining, or updating models, and/or other processing steps. In at least one embodiment, DICOM adapter 902a can be used to access DICOM data. In at least one embodiment, for different machine learning models used by deployment system 806, different training pipeline(s) 904 may be used. In at least one embodiment, training pipeline(s) 904, similar to a first example described with respect to FIG. 8, may be used for a first machine learning model, training pipeline(s) 904, similar to a second example described with respect to FIG. 8, may be used for a second machine learning model, and training pipeline(s) 904, similar to a third example described with respect to FIG. 8, may be used for a third machine learning model. In at least one embodiment, any combination of tasks within training system 804 may be used depending on what is required for each respective machine learning model. In at least one embodiment, one or more of machine learning models may already be trained and ready for deployment so machine learning models may not undergo any processing by training system 804 and may be implemented by deployment system 806.

In at least one embodiment, output model(s) 816 and/or pre-trained models 906 may include any types of machine learning models depending on embodiment. In at least one embodiment, and without limitation, machine learning models used by system 900 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 904 may include AI-assisted annotation. In at least one embodiment, labeled data 812 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 808 (or other data type used by machine learning models), there may be corresponding ground truth data generated by training system 804. In at least one embodiment, AI-assisted annotation may be performed as part of deployment pipeline(s) 910; either in addition to, or in lieu of, AI-assisted annotation included in training pipeline(s) 904. In at least one embodiment, system 900 may include a multi-layer platform that may include a software layer (e.g., software 818) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 802. In at least one embodiment, applications may then call or execute one or more services 820 for performing compute, AI, or visualization tasks associated with respective applications, and software 818 and/or services 820 may leverage hardware 822 to perform processing tasks in an effective and efficient manner.

In at least one embodiment, deployment system 806 may execute deployment pipelines 910. In at least one embodiment, deployment pipeline(s) 910 may include any number of applications that may be sequentially, non-sequentially, or otherwise applied to feedback data (and/or other data types), including AI-assisted annotation, as described above. In at least one embodiment, as described herein, a deployment pipeline(s) 910 for an individual device may be referred to as a virtual instrument for a device. In at least one embodiment, for a single device, there may be more than one deployment pipeline(s) 910 depending on information desired from data generated by a device.

In at least one embodiment, applications available for deployment pipeline(s) 910 may include any application that may be used for performing processing tasks on feedback data or other data from devices. In at least one embodiment, because various applications may share common image operations, in some embodiments, a data augmentation library (e.g., as one of services 820) may be used to accelerate these operations. In at least one embodiment, to avoid bottlenecks of conventional processing approaches that rely on CPU processing, parallel computing platform 930 may be used for GPU acceleration of these processing tasks.

In at least one embodiment, deployment system 806 may include a user interface (UI) 914 (e.g., a graphical user interface, a web interface, etc.) that may be used to select applications for inclusion in deployment pipeline(s) 910, arrange applications, modify or change applications or parameters or constructs thereof, use and interact with deployment pipeline(s) 910 during set-up and/or deployment, and/or to otherwise interact with deployment system 806. In at least one embodiment, although not illustrated with respect to training system 804, UI 914 (or a different user interface) may be used for selecting models for use in deployment system 806, for selecting models for training, or retraining, in training system 804, and/or for otherwise interacting with training system 804.

In at least one embodiment, pipeline manager 912 may be used, in addition to an application orchestration system 928, to manage interaction between applications or containers of deployment pipeline(s) 910 and services 820 and/or hardware 822. In at least one embodiment, pipeline manager 912 may be configured to facilitate interactions from application to application, from application to service 820, and/or from application or service to hardware 822. In at least one embodiment, although illustrated as included in software 818, this is not intended to be limiting, and in some examples pipeline manager 912 may be included in services 820. In at least one embodiment, application orchestration system 928 (e.g., Kubernetes, DOCKER, etc.) may include a container orchestration system that may group applications into containers as logical units for coordination, management, scaling, and deployment. In at least one embodiment, by associating applications from deployment pipeline(s) 910 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 912 and application orchestration system 928. In at least one embodiment, so long as an expected input and/or output of each container or application is known by a system (e.g., based on constructs of applications or containers), application orchestration system 928 and/or pipeline manager 912 may facilitate communication among and between, and sharing of resources among and between, each of the applications or containers. In at least one embodiment, because one or more of applications or containers in deployment pipeline(s) 910 may share the same services and resources, application orchestration system 928 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 928) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 820 leveraged and shared by applications or containers in deployment system 806 may include compute service(s) 916, collaborative content creation service(s) 917, AI service(s) 918, simulation service(s) 919, visualization service(s) 920, and/or other service types. In at least one embodiment, applications may call (e.g., execute) one or more of services 820 to perform processing operations for an application. In at least one embodiment, compute service(s) 916 may be leveraged by applications to perform super-computing or other high-performance computing (HPC) tasks. In at least one embodiment, compute service(s) 916 may be leveraged to perform parallel processing (e.g., using a parallel computing platform 930) for processing data through one or more of applications and/or one or more tasks of a single application, substantially simultaneously. In at least one embodiment, parallel computing platform 930 (e.g., NVIDIA's CUDA®) may enable general purpose computing on GPUs (GPGPU) (e.g., GPUs/graphics 922). In at least one embodiment, a software layer of parallel computing platform 930 may provide access to virtual instruction sets and parallel computational elements of GPUs, for execution of compute kernels. In at least one embodiment, parallel computing platform 930 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 930 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 918 may be leveraged to perform inferencing services for executing machine learning model(s) associated with applications (e.g., tasked with performing one or more processing tasks of an application). In at least one embodiment, AI service(s) 918 may leverage AI system(s) 924 to execute machine learning model(s) (e.g., neural networks, such as CNNs) for segmentation, reconstruction, object detection, feature detection, classification, and/or other inferencing tasks. In at least one embodiment, applications of deployment pipeline(s) 910 may use one or more of output model(s) 816 from training system 804 and/or other models of applications to perform inference on imaging data (e.g., DICOM data, RIS data, CIS data, REST compliant data, RPC data, raw data, etc.). For example, DICOM adapter 902b may be used to access DICOM data. In at least one embodiment, two or more examples of inferencing using application orchestration system 928 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 928 may distribute resources (e.g., services 820 and/or hardware 822) based on priority paths for different inferencing tasks of AI service(s) 918.

In at least one embodiment, shared storage may be mounted to AI service(s) 918 within system 900. In at least one embodiment, shared storage may operate as a cache (or other storage device type) and may be used to process inference requests from applications. In at least one embodiment, when an inference request is submitted, a request may be received by a set of API instances of deployment system 806, and one or more instances may be selected (e.g., for best fit, for load balancing, etc.) to process a request. In at least one embodiment, to process a request, a request may be entered into a database, a machine learning model may be located from model registry 824 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 912) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 820 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 926, and an inference service may perform inferencing on a GPU.

In at least one embodiment, visualization service(s) 920 may be leveraged to generate visualizations for viewing outputs of applications and/or deployment pipeline(s) 910. In at least one embodiment, GPUs/graphics 922 may be leveraged by visualization service(s) 920 to generate visualizations. In at least one embodiment, rendering effects, such as ray-tracing or other light transport simulation techniques, may be implemented by visualization service(s) 920 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 920 may include an internal visualizer, cinematics, and/or other rendering or image processing capabilities or functionality (e.g., ray tracing, rasterization, internal optics, etc.).

In at least one embodiment, hardware 822 may include GPUs/graphics 922, AI system(s) 924, cloud 926, and/or any other hardware used for executing training system 804 and/or deployment system 806. In at least one embodiment, GPUs/graphics 922 (e.g., NVIDIA's TESLA® and/or QUADRO® GPUs) may include any number of GPUs that may be used for executing processing tasks of compute service(s) 916, collaborative content creation service(s) 917, AI service(s) 918, simulation service(s) 919, visualization service(s) 920, other services, and/or any of features or functionality of software 818. For example, with respect to AI service(s) 918, GPUs/graphics 922 may be used to perform pre-processing on imaging data (or other data types used by machine learning models), post-processing on outputs of machine learning models, and/or to perform inferencing (e.g., to execute machine learning models). In at least one embodiment, cloud 926, AI system(s) 924, and/or other components of system 900 may use GPUs/graphics 922. In at least one embodiment, cloud 926 may include a GPU-optimized platform for deep learning tasks. In at least one embodiment, AI system(s) 924 may use GPUs, and cloud 926—or at least a portion tasked with deep learning or inferencing—may be executed using one or more AI system(s) s 924. As such, although hardware 822 is illustrated as discrete components, this is not intended to be limiting, and any components of hardware 822 may be combined with, or leveraged by, any other components of hardware 822.

In at least one embodiment, AI system(s) 924 may include a purpose-built computing system (e.g., a super-computer or an HPC) configured for inferencing, deep learning, machine learning, and/or other artificial intelligence tasks. In at least one embodiment, AI system(s) 924 (e.g., NVIDIA's DGX™) may include GPU-optimized software (e.g., a software stack) that may be executed using a plurality of GPUs/graphics 922, in addition to CPUs, RAM, storage, and/or other components, features, or functionality. In at least one embodiment, one or more AI system(s) s 924 may be implemented in cloud 926 (e.g., in a data center) for performing some or all of AI-based processing tasks of system 900.

In at least one embodiment, cloud 926 may include a GPU-accelerated infrastructure (e.g., NVIDIA's NGC™) that may provide a GPU-optimized platform for executing processing tasks of system 900. In at least one embodiment, cloud 926 may include an AI system(s) 924 for performing one or more of AI-based tasks of system 900 (e.g., as a hardware abstraction and scaling platform). In at least one embodiment, cloud 926 may integrate with application orchestration system 928 leveraging multiple GPUs to enable seamless scaling and load balancing between and among applications and services 820. In at least one embodiment, cloud 926 may be tasked with executing at least some of services 820 of system 900, including compute service(s) 916, AI service(s) 918, and/or visualization service(s) 920, as described herein. In at least one embodiment, cloud 926 may perform small and large batch inference (e.g., executing NVIDIA's TensorRT™), provide an accelerated parallel computing platform 930 (e.g., NVIDIA's CUDA®), execute application orchestration system 928 (e.g., KUBERNETES), provide a graphics rendering API and platform (e.g., for ray-tracing, 2D graphics, 3D graphics, and/or other rendering techniques to produce higher quality cinematics), and/or may provide other functionality for system 900. In at least one embodiment, parallel computing platform 930 may include an API.

In at least one embodiment, in an effort to preserve patient confidentiality (e.g., where patient data or records are to be used off-premises), cloud 926 may include a registry, such as a deep learning container registry. In at least one embodiment, a registry may store containers for instantiations of applications that may perform pre-processing, post-processing, or other processing tasks on patient data. In at least one embodiment, cloud 926 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving first metrics including a first number of work requests for a first task received within a first predetermined duration;
applying an artificial intelligence (AI) model to the first number of work requests for the first task to obtain a first predicted number of future work requests for the first task, wherein the AI model comprises a prediction function comprising one or more autoregressive terms and Fourier series terms; and
causing the first predicted number of future work requests for the first task to be provided to a worker controller for managing a first plurality of workers deployed within a first compute environment to execute the first task.

2. The method of claim 1, wherein the one or more autoregressive terms and Fourier series terms have corresponding weights, and wherein the AI model is trained to determine weights that minimize a difference between the first predicted number of future work requests for the first task and a ground truth number of work requests.

3. The method of claim 1, further comprising:
determining, based on the first predicted number of future work requests for the first task, a first predicted number of future workers for the first task; and
causing the first predicted number of future workers for the first task to be provided to the worker controller.

4. The method of claim 3, wherein the first metrics further include a first average work request compute duration for the first task, and wherein the determining the first predicted number of future workers for the first task is further based on the first average work request compute duration for the first task.

5. The method of claim 4, further comprising:
receiving second metrics including a second number of work requests for a second task received within a second predetermined duration;
applying the AI model to the second number of work requests for the second task to obtain a second predicted number of future work requests for the second task; and
causing the second predicted number of future work requests for the second task to be provided to the worker controller for managing a second plurality of workers deployed within a second compute environment to execute the second task.

6. The method of claim 5, further comprising:
determining, based on the second predicted number of future work requests for the second task, a second predicted number of future workers for the second task; and
causing the second predicted number of future workers for the second task to be provided to the worker controller for managing the second plurality of workers deployed within the second compute environment to execute the second task.

7. The method of claim 6, wherein:
the second metrics further include a second average work request compute duration for the second task;
the second average work request compute duration for the second task is different than the first average work request compute duration for the first task; and
the determining the second predicted number of future workers for the second task is further based on the second average work request compute duration for the second task.

8. The method of claim 1, further comprising:
determining a first work requests buffer amount of the first task based on a variability of work request compute duration for the first task; and
modifying the first predicted number of future work requests based on the first work requests buffer amount.

9. A method comprising:
receiving, at a worker controller managing ongoing allocation of workers for a first task, a first predicted number of future work requests for the first task, wherein the first predicted number of future work requests is determined using an artificial intelligence (AI) model and metrics related to work requests received for the first task;
determining a first predicted number of future workers for the first task based at least on the first predicted number of future work requests for the first task;
determining a first computing resource utilization level corresponding to a first number of active workers for the first task; and
responsive to the first computing resource utilization level satisfying a load criterion, modifying the first number of active workers for the first task based on the first predicted number of future workers for the first task.

10. The method of claim 9, wherein the first predicted number of future workers for the first task is further based on a first average work request compute duration for the first task.

11. The method of claim 9, wherein the load criterion comprises a first threshold, and wherein the modifying the first number of workers for the first task based on the first predicted number of future workers for the first task comprises, responsive to the first computing resource utilization level exceeding the first threshold, increasing the first number of workers for the first task based on the first predicted number of future workers for the first task.

12. The method of claim 9, wherein the load criterion comprises a second threshold, and wherein the modifying the first number of workers for the first task based on the first predicted number of future workers for the first task comprises, responsive to the first computing resource utilization level falling below the second threshold, decreasing the first number of workers for the first task based on the first predicted number of future workers for the first task.

13. The method of claim 9, further comprising:
receiving, at the worker controller, a second predicted number of future work requests for a second task;
determining a second predicted number of future workers for the second task based at least on the second predicted number of future work requests for the second task;
determining a second computing resource utilization level corresponding to a second number of workers for the second task; and
responsive to the second computing resource utilization level satisfying the load criterion, modifying the second number of workers of the second task based on the second predicted number of future workers for the second task.

14. The method of claim 9, wherein the first computing resource utilization level is based on metrics aggregated from one or more computing environments hosting the first number of active workers for the first task.

15. A method comprising:
determining a first excess work amount for a first queue for a first task based on a size of the first queue for the first task, a first average work request compute duration for the first task, and a first number of workers for the first task;
determining a first number of additional workers for the first task based on the first excess work amount for the first queue and a first startup time of a worker process of the first task; and
causing the first number of additional workers for the first task to be provided to a worker controller for managing a first plurality of workers deployed within a first compute environment to execute the first task.

16. The method of claim 15, wherein determining the first excess work amount for the first queue for the first task is further based on a first rate of change of the size of the first queue for the first task.

17. The method of claim 15, wherein the first number of workers for the first task comprises a first set of workers for the first task in a ready state and a first set of workers for the first task in a startup state.

18. The method of claim 15, wherein determining the first number of additional workers for the first task is further based on a resource availability of a device hosting one or more workers.

19. The method of claim 15, further comprising:
determining a second excess work amount for a second queue for a second task based on a size of the second queue for the second task, a second average work request compute duration for the second task, and a second number of workers for the second task;
determining a second number of additional workers for the second task based on the second excess work amount for the second queue and a second startup time of a worker process of the second task; and
causing the second number of additional workers for the second task to be provided to the worker controller for managing a second plurality of workers deployed within a second compute environment to execute the second task.

20. The method of claim 19, further comprising:
determining a first additional worker efficiency value for the first task based on the size of the first queue for the first task and the first startup time of a worker process of the first task; and
determining a second additional worker efficiency value for the second task based on the size of the second queue for the second task and the second startup time of a worker process of the second task, wherein causing the second number of additional workers for the second task to be provided to the worker controller is based on the second additional worker efficiency value being higher than the first additional worker efficiency value.
